(19) United States
(12) Patent Application Publication
(10) Pub. No.: US 2001/0054821 A1
(43) Pub. Date: Dec. 27, 2001

(54) Fitting with pressure relief vent

(76) Inventor: Steven J. Volcansek, Hudson, OH (US)

Correspondence Address: CALFEE HALTER & GRISWOLD, LLP, 800 SUPERIOR AVENUE, SUITE 1400, CLEVELAND, OH, 44114, US

(21) Appl. No.: 09/887,278

(22) Filed: Jun. 22, 2001

Related U.S. Application Data
(60) Provisional application No. 60/213,692, filed on Jun. 23, 2000.

(51) Int. Cl. F16L 13/14

(52) U.S. Cl. 285/382.7

(57) ABSTRACT

A tube fitting has: a body having a bore for receiving a tube end and includes a tapered mouth at one end of the body; a drive member having a threaded engagement with the body and having a drive surface; a first ferrule having a tapered first end that extends into the tapered mouth of the body and having a second end with a tapered recess that axially extends toward the first end; and a second ferrule having a tapered first end that extends into the tapered recess of the first ferrule, and having a driven surface on a second end thereof that engages the drive member drive surface; the first ferrule having an outer generally conical surface that forms the tapered first end and forms a seal with the tapered mouth when the fitting is assembled and tightened. The fitting includes a vent in the form of a hole, bore or other fluid passageway in the drive member to relieve pressure when the drive member is at least partly loosened from the body.

### RELATED APPLICATIONS

This application claims the benefit of pending U.S. provisional patent application Ser. No. 60/213,692 filed on Jun. 23, 2000, the entire disclosure of which is fully incorporated herein by reference.

### TECHNICAL FIELD OF THE INVENTION

The subject invention is generally directed to the art of ferrule type tube fittings. More particularly, the invention concerns a tube fitting having a vent for relieving system pressure when the fitting is partly disassembled under pressure.

### BACKGROUND OF THE INVENTION

Tube fittings are well known to those skilled in the art. A typical two ferrule tube fitting is described in U.S. Pat. No. 3,103,373 issued to Lennon, et al., the entire disclosure of which is fully incorporated herein by reference. In some cases, such a fitting may be loosened or an attempt may be made to disassemble the fitting even though there is system pressure in the line. The present invention is directed to providing a way to relieve the pressure so that there is not a sudden or uncontrolled release of pressure.

### SUMMARY OF THE INVENTION

The present invention contemplates a tube fitting that permits pressure in line or tubing to be vented to atmosphere should the fitting be loosened with the fitting under pressure. In accordance with one embodiment of the invention, the fitting includes a nut that is threaded onto a fitting body. The nut is provided with one or more vent holes that permit the release of pressure when the fitting is at least partly disassembled.

In accordance with another aspect of the invention, a tube fitting nut is provided with a vent means to release system pressure by directing any fluid in a predetermined direction. In one embodiment, the vent means is realized in the form of a vent hole that is angled outwardly and away from a seal location that is released when the fitting is partly disassembled.

In accordance with another aspect of the invention, pressurized fluid that is released when the fitting is at least partly disassembled is constrained so as to be released in a prescribed manner. In one embodiment, a diffuser collar is installed on the outside of the fitting nut and/or body near a vent hole so as to redirect the fluid in a predetermined direction or manner.

These and other aspects and advantages of the present invention will be apparent to those skilled in the art from the following description of the preferred embodiments in view of the accompanying drawings.

### BRIEF DESCRIPTION OF THE DRAWINGS

The invention may take physical form in certain parts and arrangements of parts, preferred embodiments and a method of which will be described in detail in this specification and illustrated in the accompanying drawings which form a part hereof, and wherein:

FIG. 1 is a longitudinal cross-sectional view of a well-known prior art two ferrule swage-type fitting that incorporates one embodiment of the invention;

FIG. 2 is an enlarged view of the circled area of FIG. 1;

FIG. 3 is a perspective showing an embodiment of a diffuser in accordance with the invention; and

FIG. 4 illustrates a two ferrule tube fitting that incorporates the present invention, with the fitting shown in a pulled-up condition.

### DETAILED DESCRIPTION OF THE PREFERRED EMBODIMENTS

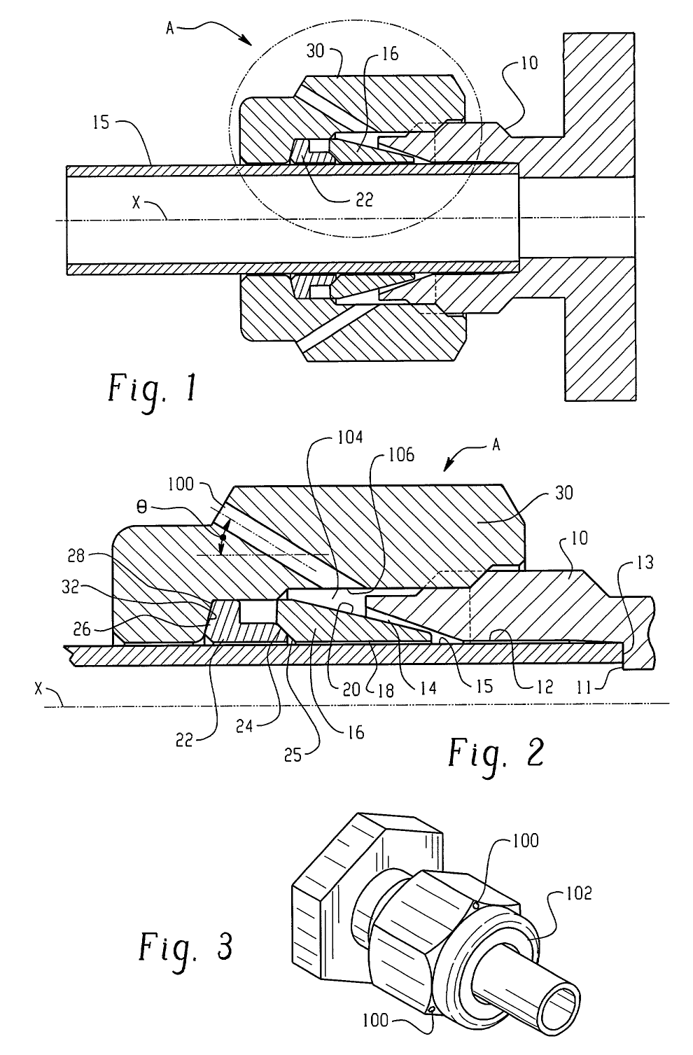

A commercially available and highly successful two ferrule fitting A used for tubing is illustrated in FIGS. 1-3. The drawings illustrate the fitting A components in a finger tight position preparatory to final tightening or make-up of the fitting. As shown, the fitting comprises a body 10 having a cylindrical opening 12 with a counterbore 11 for receiving a tube end 13. A tapered, frusto-conical camming mouth 14 is located at the axial outer end of the counterbore 11. A front ferrule 16 having a smooth, cylindrical inner wall 18 is closely received on the tube outer wall 15. The front ferrule has a frusto-conical outer surface 20 that is received in the camming mouth 14.

Associated with the front ferrule 16 and located axially adjacent thereto is a rear ferrule 22 configured as shown with a tapered conical nose portion 24 and a rear flange 26 having an inclined or otherwise contoured driven end surface 28. The driven end surface 28 of the rear ferrule 22 provides a radial component as well as an axial component of the pull-up forces acting on the end surface as will be apparent to those skilled in the art. The tapered nose 24 enters a tapered camming surface 25 formed at the rear end of the front ferrule 16.

The ferrules 16, 22 are enclosed by a drive nut member 30 threaded to the body 10. During tightening and make-up of the fitting, the inner end face, flange, or shoulder 32 of the nut 30 acts against the rear wall driven end surface 28 of the rear ferrule to drive the ferrules forwardly into the fully engaged or pulled up position as is well known to those skilled in the art. As used herein, “pull up” and “make up” of the fitting A are used interchangeably.

The small diameter portion or nose 24 of the rear ferrule 22 is dimensioned so that it plastically deforms during make-up of the fitting. This action is desirable since it results in tight gripping engagement of the outer wall 15 of the tube end 13. That is, the two ferrule assembly requires desired deformation of both the front and rear ferrules for the gripping and sealing capabilities that have made this two ferrule assembly a commercially successful product.

A more complete description and understanding of the conventional two ferrule phase controlled sequential gripping action resulting from the inclined rear surface and the interaction of the front and rear ferrules is set forth in U.S. Pat. No. 3,103,373 issued to Lennon, et al., the entire disclosure of which is fully incorporated herein by reference.

During pull-up, a primary seal is formed between the outer conical surface 20 of the front ferrule 16. This seal is used to contain whatever fluid is flowing through the tube 13 from escaping under pressure. Note that the nut 30 is threaded onto the body 10, and in many cases the threaded connection is tight enough to contain the fluid under pressure even if the primary seal is lost. The front ferrule 16 is also swaged onto the tube 13 to provide a seal against fluid pressure along the outer surface 15 of the tube.

The fluid that is passing through the tube may be gas or liquid and may be under pressure. When pressurized, it is preferred that the pressure be relieved before the fitting A is disassembled. But in some applications, it may not be possible to relieve system pressure prior to disassembly of the fitting A. In any case, occasionally a fitting may be loosened in error without the operator realizing that the fluid is still under pressure.

The present invention is directed to the concept of relieving or venting the fluid pressure to atmosphere in a controlled manner for a limited volume system. In accordance with the invention, the fluid pressure is preferably released in a direction that is away from the operator, or otherwise diffused or controlled.

In the embodiment of the Figures, the invention is realized in the form of one or more vents, holes or passageways 100 machined into the nut 30. The vent 100 is machined at an angle θ relative to the longitudinal axis X of the tubing 13. In the illustrated example, θ is about 30°, but the selected value of θ will depend on the particular design of the fitting A. The size of the vent 100 may be selected to provide sufficient volume to quickly vent the fluid at the working pressure. For example and not by way of limitation, three vents of about 1/32″ diameter can easily relieve pressures of about 5000 psi in a limited volume system. In accordance with one aspect of the invention, the vent 100 is angled such that fluid escaping from a primary seal area (such as the front ferrule seal between the ferrule and body surfaces 20 and 14) can flow directly into the vent 100 without having to make any significant turns in the flow path. The vent 100 is also directed at the angle θ so as to provide an axial direction to the vented fluid, rather than primarily radially towards the operator. The vent 100 provides a path of least resistance for the fluid and prevents axial and/or radial forces on the nut from the pressurized fluid.

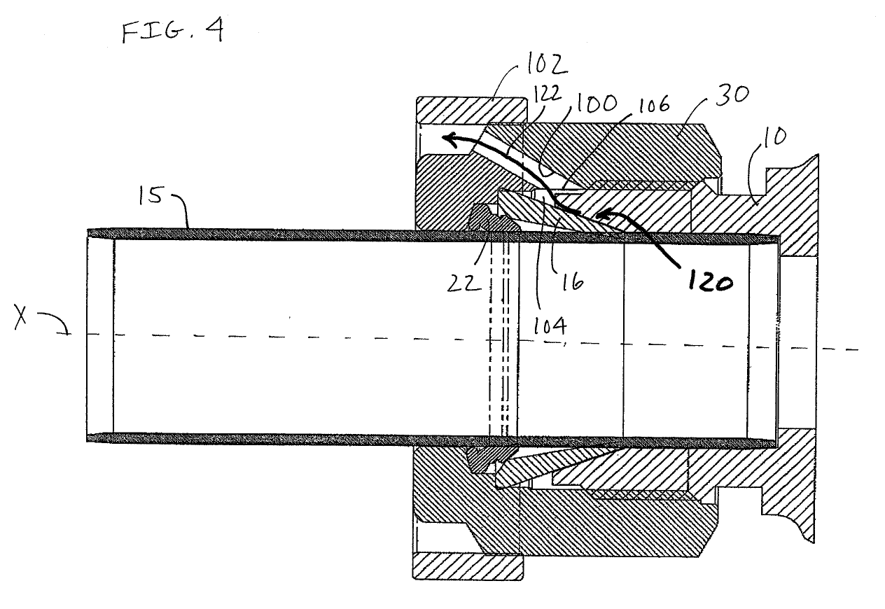

The nut 30 and the body 10 form a cavity 104 when assembled. The vent 100 has an opening 106 that opens to the cavity 104 in a region that is near or adjacent the seal region of the seal formed between the front ferrule 16 and the body 10. When the fitting A is fully made-up, the opening 106 may axially be positioned somewhat further to the right as viewed in FIG. 2, but generally will still provide a rather direct path for fluid to be vented to atmosphere from the seal region. This condition is illustrated in FIG. 4. The FIG. 4 embodiment illustrates a different shaped rear ferrule, but the use of the present invention is the same. The diffuser collar 102 is also shown installed. In the pulled-up position, the vent 100 at orifice 106 still opens to the cavity 104 near the front ferrule seal area 120. As represented by the directional arrow 122, any fluid that is released when the nut 30 is partially backed off, will easily flow out the vent 100, and further be directed axially by the optional collar 102 (and still have an axial directional component even when the collar 102 is not used).

In accordance with another aspect of the invention, the direction of the vented fluid can be further constrained or redirected by the use of an optional diffuser collar or sleeve 102 (see FIG. 3). This sleeve 102 may be of any suitable material such as metal or plastic and can be press fit assembled onto the nut 30 in the proximate area of the vents 100. The vented fluid is diffused by the sleeve 102, again primarily to prevent fluid from being directed toward the operator. In many cases, however, the fluid pressure is relieved fast enough that the collar 102 is unnecessary.

FIG. 3 illustrates that more than one vent 100 may be used, such as, for example, three vents equidistantly spaced about the perimeter of the nut 30. The use of multiple vents 100 permits the pressure to be released quickly and uniformly without a pressure imbalance being applied to the nut.

The present invention has been described herein with reference to a particular two ferrule tube fitting, however, the present invention will find suitable application in many different types of ferrule-style tube fittings, including but not limited to single ferrule fittings.

The invention has been described with reference to the preferred embodiment. Obviously, modifications and alterations will occur to others upon a reading and understanding of this specification. It is intended to include all such modifications and alterations insofar as they come within the scope of the appended claims or the equivalents thereof.

Having thus described the invention, it is claimed:

1. A tube fitting comprising: a body having a bore for receiving a tube end and including a tapered mouth at one end of the body; a drive member having a threaded engagement with said body and having a drive surface; a first ferrule having a tapered first end that extends into said tapered mouth of said body and having a second end with a tapered recess that axially extends toward said first end; and a second ferrule having a tapered first end that extends into said tapered recess of said first ferrule, and having a driven surface on a second end thereof that engages said drive member drive surface; said first ferrule having an outer generally conical surface that forms said tapered first end and forms a seal with said tapered mouth when the fitting is assembled and tightened; and a vent means in said drive member to relieve pressure when the drive member is at least partly loosened.

2. The fitting of claim 1 wherein said vent means comprises a hole that extends through said drive member.

3. The fitting of claim 1 wherein said vent means comprises a bore through said drive member; said bore opening toward said seal.

4. The fitting of claim 3 wherein said bore is formed along an axis at an angle relative to a longitudinal axis of the tube end.

5. The fitting of claim 4 wherein said angle is about 30°.

6. The fitting of claim 1 comprising a sleeve that is installed on said drive member and directs fluid from said vent means to be released in a controlled manner.

7. A tube fitting comprising: a body having a bore for receiving a tube end; a nut having a threaded engagement with said body; and at least one ferrule that is disposed within a cavity defined by the nut and body when threaded together and that forms a seal with said body; and a vent formed in said nut to release fluid pressure to atmosphere when the fitting is at least partly disassembled.

8. The tube fitting of claim 7 wherein said vent comprises an angled bore that opens to said cavity near said seal.

9. The fitting of claim 8 wherein said vent directs fluid along an axial direction away from an operator.

10. The fitting of claim 7 comprising a sleeve installed on said nut proximate said vent.

11. The fitting of claim 7 comprising a plurality of vents formed in said nut.

12. A tube fitting comprising: a body having a bore for receiving a tube end; a nut having a threaded engagement with said body; and at least one ferrule that is disposed within a cavity defined by the nut and body when threaded together and that forms a seal with said body; and means for releasing pressure in said tube end when the fitting is at least partly disassembled, said means being integral with said nut and providing a fluid path from a region near said seal to atmosphere.

13. A tube fitting comprising: a body having a bore for receiving a tube end; a nut having a threaded engagement with said body; and at least one ferrule that is disposed within a cavity defined by the nut and body when threaded together and that forms a seal with said body; and a fluid passageway for releasing pressure in said tube end when the fitting is at least partly disassembled, said fluid passageway being integral with said nut and providing a fluid path from a region near said seal to atmosphere.
